(19) United States
(12) Patent Application Publication
(10) Pub. No.: US 2015/0277433 A1
(43) Pub. Date: Oct. 1, 2015

(54) INFORMATION PROCESSING DEVICE, INFORMATION PROCESSING METHOD, AND NON-TRANSITORY COMPUTER-READABLE MEDIUM

(71) Applicant: FUJI XEROX CO., LTD., Tokyo (JP)

(72) Inventors: Toshihiro NUMAUCHI, Kanagawa (JP); Masanori YOSHIZUKA, Kanagawa (JP)

(73) Assignee: FUJI XEROX CO., LTD., Tokyo (JP)

(21) Appl. No.: 14/626,263

(22) Filed: Feb. 19, 2015

(30) Foreign Application Priority Data
Mar. 27, 2014 (JP) 2014-066288

(51) Int. Cl. G05B 19/4097

(52) U.S. Cl. CPC G05B 19/4097; G05B 2219/35008

(57) ABSTRACT

An information processing device includes a receiving unit, an inspection unit, a generating unit, and an output unit. The receiving unit receives three-dimensional (3D) information at least including a 3D shape. The inspection unit conducts, on the 3D information, a mold requirement inspection at least including undercut as a mold requirement inspection for fabricating an object represented by the 3D information. When the inspection unit detects an inexpedient part, the generating unit generates inexpedience information for creating a 3D representation of the inexpedient part. The output unit outputs the inexpedience information in association with an inspection item.

### CROSS-REFERENCE TO RELATED APPLICATIONS

This application is based on and claims priority under 35 USC 119 from Japanese Patent Application No. 2014-066288 filed Mar. 27, 2014.

### BACKGROUND

The present invention relates to an information processing device, an information processing method, and a non-transitory computer-readable medium.

### SUMMARY

According to an aspect of the invention, there is provided an information processing device including a receiving unit that receives three-dimensional (3D) information at least including a 3D shape, an inspection unit that conducts, on the 3D information, a mold requirement inspection at least including undercut as a mold requirement inspection for fabricating an object represented by the 3D information, a generating unit that, when the inspection unit detects an inexpedient part, generates inexpedience information for creating a 3D representation of the inexpedient part, and an output unit that outputs the inexpedience information in association with an inspection item.

### BRIEF DESCRIPTION OF THE DRAWINGS

An exemplary embodiment of the present invention will be described in detail based on the following figures, wherein:

FIG. 1 is a schematic module configuration diagram for an exemplary configuration according to an exemplary embodiment;

FIG. 2 is an explanatory diagram illustrating an exemplary system configuration applying an exemplary embodiment;

FIG. 3 is a flowchart illustrating an exemplary process according to an exemplary embodiment;

FIG. 4 is an explanatory diagram illustrating an example of a screen used for an inspection request;

FIG. 5 is an explanatory diagram illustrating an example of a screen that displays an inspection result;

FIG. 6 is an explanatory diagram illustrating an example of a screen that presents a three-dimensional (3D) display of an inspection result;

FIG. 7 is an explanatory diagram illustrating an example of combinations of display formats for inspection items;

FIG. 8 is an explanatory diagram illustrating an exemplary display of an inspection result;

FIG. 9 is an explanatory diagram illustrating an exemplary display of an inspection result;

FIGS. 10A and 10B are explanatory diagrams illustrating an exemplary display of an inspection result;

FIG. 11 is an explanatory diagram illustrating an exemplary display of an inspection result;

FIG. 12 is an explanatory diagram illustrating an exemplary display of an inspection result;

FIG. 13 is an explanatory diagram illustrating an exemplary display of an inspection result;

FIG. 14 is an explanatory diagram illustrating an exemplary display of an inspection result; and

FIG. 15 is a block diagram illustrating an exemplary hardware configuration of a computer that realizes an exemplary embodiment.

### DETAILED DESCRIPTION

Hereinafter, an exemplary embodiment related to realizing the present invention will be described by way of example on the basis of the drawings.

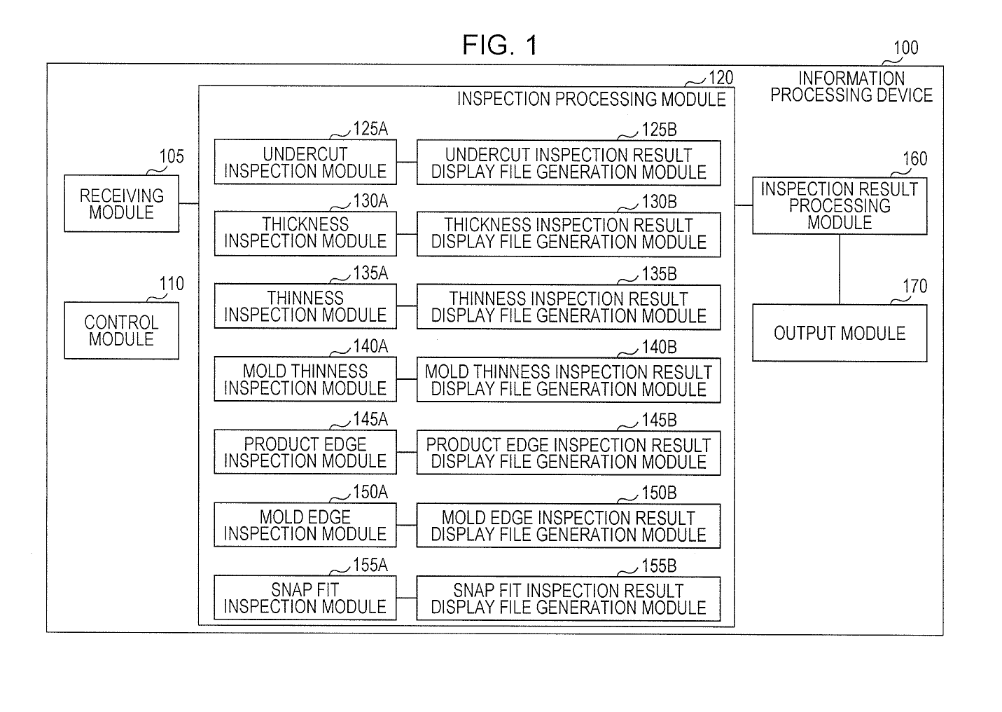

FIG. 1 illustrates a schematic module configuration for an exemplary configuration according to the exemplary embodiment.

Note that the term module refers to components such as software (computer programs) and hardware which are typically capable of being logically separated. Consequently, the term module in the exemplary embodiment not only refers to modules in a computer program, but also to modules in a hardware configuration. Thus, the exemplary embodiment also serves as a description of a computer program (a program that causes a computer to execute respective operations, a program that causes a computer to function as respective units, or a program that causes a computer to realize respective functions), a system, and a method for inducing functionality as such modules. Note that although terms like “store” and “record” and their equivalents may be used in the description for the sake of convenience, these terms mean that a storage device is made to store information or that control is applied to cause a storage device to store information in the case where the exemplary embodiment is a computer program. Also, while modules may be made to correspond with function on a one-to-one basis, some implementations may be configured such that one program constitutes one module, such that one program constitutes multiple modules, or conversely, such that multiple programs constitute one module. Moreover, multiple modules may be executed by one computer, but one module may also be executed by multiple computers in a distributed or parallel computing environment. Note that a single module may also contain other modules. Also, the term “connection” may be used hereinafter to denote logical connections (such as the transfer of data and referential relationships between instructions and data) in addition to physical connections. The term “predetermined” refers to something being determined prior to the processing in question, and obviously denotes something that is determined before a process according to the exemplary embodiment starts, but may also denote something that is determined after a process according to the exemplary embodiment has started but before the processing in question, according to conditions or states at that time, or according to conditions or states up to that time. In the case of multiple “predetermined values”, the predetermined values may be respectively different values, or two or more values (this obviously also includes the case of all values) which are the same. Additionally, statements to the effect of “B is conducted in the case of A” are used to denote that a determination is made regarding whether or not A holds true, and B is conducted in the case where it is determined that A holds true. However, this excludes cases where the determination of whether or not A holds true may be omitted.

Also, the terms “system” and “device” not only encompass configurations in which multiple computers, hardware, or devices are connected by a communication medium such as a network (including connections that support 1-to-1 communication), but also encompass configurations realized by a single computer, hardware, or device. The terms “device” and “system” are used interchangeably. Obviously, the term “system” does not include merely artificially arranged social constructs (social systems).

Also, every time a process is conducted by each module or every time multiple processes are conducted within a module, information to be processed is retrieved from a storage device, and the processing results are written back to the storage device after the processing. Consequently, description of the retrieval from a storage device before processing and the writing back to a storage device after processing may be reduced or omitted in some cases. Note that the storage device herein may include a hard disk, random access memory (RAM), an auxiliary or external storage medium, a storage device accessed via a communication link, and a register or the like inside a central processing unit (CPU).

An information processing device 100 according to the exemplary embodiment outputs a result of conducting an inspection that includes undercut inspection on three-dimensional (3D) information (hereinafter also designated mold inspection, or simply “inspection”). As illustrated in the example of FIG. 1, the information processing device 100 includes a receiving module 105, a control module 110, an inspection processing module 120, an inspection result processing module 160, and an output module 170.

The receiving module 105 is connected to the inspection processing module 120. The receiving module 105 receives at least 3D information to be inspected. The 3D information is data generated by 3D computer-aided design (CAD) (including information such as intermediate data and compatibility information for conversion to another CAD tool), and is a file in a format such as Parasolid. The 3D information is for the purpose of creating a mold (for example, a die) that produces an object represented by 3D information.

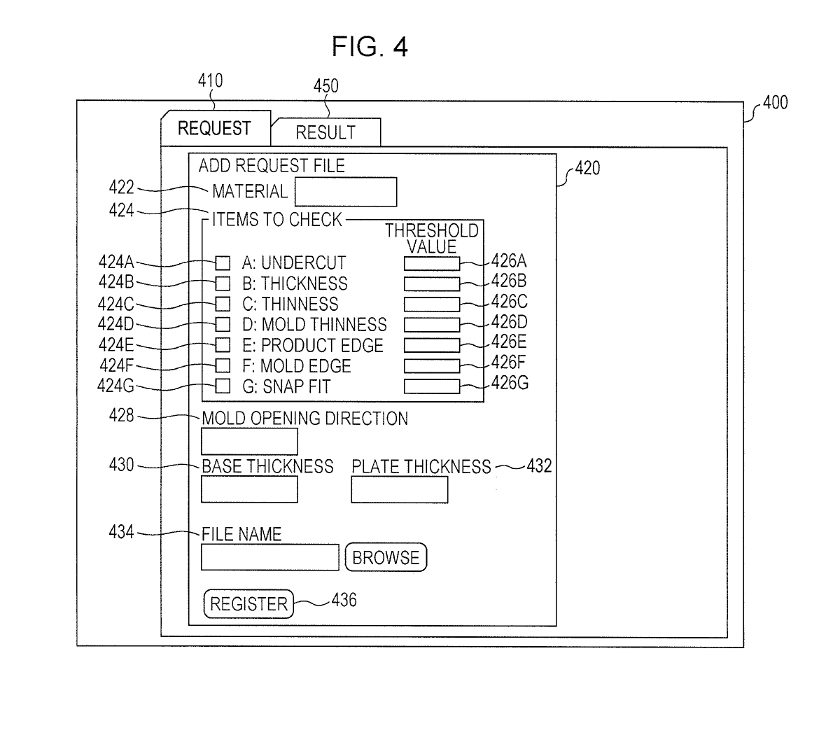

Consequently, that which is represented by the 3D information is an “object produced by the mold” or a “mold”, and is designated the “object represented by the 3D information” when discussing an object produced by the mold, and is designated the “mold represented by the 3D information” when discussing the mold. The receiving of the 3D information may be the receiving of the 3D information itself, or the specification of a file name stored in a storage device (such as a file server) accessible by the information processing device 100 (as specified by a user operation like in the example of FIG. 4 discussed later). Note that of the information received by the receiving module 105 (in other words, the information input on the user side), information other than the 3D information may be omitted, and if not input, such information may be detected automatically from the 3D information, or predetermined values may be used.

Also, the 3D information received by the receiving module 105 may also be configured to not include history information indicating a history of operations for creating that 3D information. For example, only information for forming 3D shapes may be included. In other words, the inspection processing module 120 conducts an inspection from the 3D information only. Obviously, the 3D information received by the receiving module 105 may also include history information indicating a history of operations for creating that 3D information.

Furthermore, the receiving module 105 may also be configured to receive 3D information and type information indicating the type of mold represented by that 3D information. Type information includes material information indicating the material of an object fabricated by the mold. The type may be plastic or compression-molded, for example. Additionally, types such as forged, cast, die-cast, glass, and rubber may also be provided. These types may be predefined, or selectable by the user like in the example of FIG. 4 discussed later. In this case, each inspection module inside the inspection processing module 120 conducts inspection on the basis of material information received by the receiving module 105.

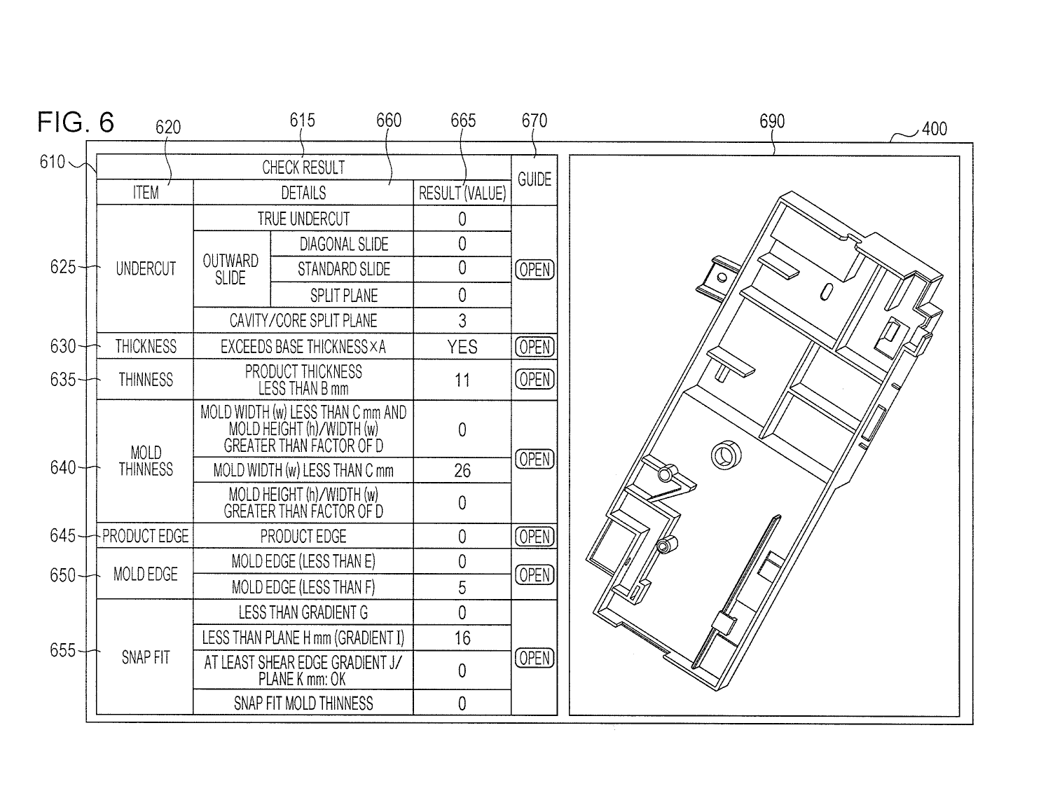

Furthermore, the receiving module 105 may also be configured to receive inspection items to be conducted by the inspection processing module 120. The inspection items may be undercut, thickness, thinness, mold thinness, product edge, mold edge, and snap fit, for example. In addition, the inspection items may be detailed items regarding the above items (the details field 660 illustrated in the example of FIG. 6 discussed later). These items may be predefined, or selectable by the user like in the example of FIG. 4 discussed later. In this case, each inspection module inside the inspection processing module 120 conducts inspection corresponding to the inspection items received by the receiving module 105.

Furthermore, the receiving module 105 may also be configured to receive values (including threshold values and the like) corresponding to inspection items to be conducted by the inspection processing module 120. These values are values used to inspect each inspection item. For example, the values may include values related to the base thickness in the case of plastic material (for example, a value multiplied by the base thickness (specifically, in the case of thickness, provided that a condition “inexpedience in parts that equal or exceed X times base thickness (where X=1.2, for example)” is defined, X becomes a threshold value. Obviously, the threshold value X is modifiable.), plate thickness in the case of compression-molded material, or the like. There may be one or multiple threshold values corresponding to an inspection item. These values may be predefined, or selectable by the user like in the example of FIG. 4 discussed later. In this case, each inspection module inside the inspection processing module 120 inspects the inspection items received by the receiving module 105 in accordance with the threshold values. Note that the base thickness may also be automatically detected from the 3D information. The technique of automatic detection may be configured to compute the thickness of each face of the received 3D information, and use a statistical value, for example. For the statistical value, the most frequent value of thickness (the value of thickness that is configured the most times), the average value of the thickest part and the thinnest part, or the like may be used.

Furthermore, the receiving module 105 may also be configured to receive the mold opening direction represented by the 3D information (the direction in which the product is removed from the metal mold, or the direction in which the metal mold opens and closes). The mold opening direction may be a direction such as the up-and-down direction, left-and-right direction, forward-and-back direction, or a diagonal direction with respect to a predetermined face of the object represented by the 3D information. These mold opening directions may be predefined, or selectable by the user like in the example of FIG. 4 discussed later. In this case, each inspection module inside the inspection processing module 120 conducts inspection in accordance with the mold opening direction received by the receiving module 105. The mold opening direction may also be automatically detected from the received 3D information as discussed earlier. In this case, the mold opening direction may be automatically detected if the receiving module 105 does not receive mold opening direction information (that is, if such information is not input on the user side). In other words, the inspection processing module 120 may specify a mold opening direction from the 3D information received by the receiving module 105, and each inspection module (such as the undercut inspection module 125A) may conduct inspection on the basis of the specified mold opening direction. Specifically, the received 3D information is analyzed, information such as the opening direction and the base thickness is computed, and inspection is conducted on the basis of the computed result. Note that in this case, the 3D information may be only 3D shape data indicating the shape, and in the case of analyzing 3D shape data, a CAD or other operation history may be omitted, improving cross-compatibility. In addition, the above information may be estimated from not only shape data, but also from information that is input and received.

In addition, the mold opening direction may be automatically detected from the 3D information even if the receiving module 105 receives mold opening direction information. Subsequently, if the information differs (the received mold opening direction information and the automatically detected mold opening direction information), an alarm indicating the difference may be displayed, and the user may be prompted to make a selection. Note that the above applies similarly to information other than the mold opening direction.

The control module 110 controls the information processing device 100 overall. For example, the control module 110 causes the inspection processing module 120 to conduct a process according to information received by the receiving module 105. Specifically, when an inspection item is received by the receiving module 105, the control module 110 selects a module inside the inspection processing module 120 corresponding to the inspection item, and causes that module to conduct an inspection process. If a value is received by the receiving module 105, the control module 110 causes each corresponding module inside the inspection processing module 120 to conduct an inspection process in accordance with the value. Also, if a mold opening direction represented by the 3D information is received by the receiving module 105, the control module 110 causes each corresponding module inside the inspection processing module 120 to conduct an inspection process in accordance with the received opening direction.

Additionally, the control module 110 may store inspection items and inspection parameters (values, including threshold values and the like) in correspondence with user information (including login information and the like), and when the receiving module 105 receives 3D information, the control module 110 may cause each inspection module to conduct inspection while applying the inspection items and inspection parameters corresponding to the user information.

The inspection processing module 120 is connected to the receiving module 105 and the inspection result processing module 160, and conducts an inspection for fabricating an object represented by 3D information received by the receiving module 105. The inspection processing module 120 includes an undercut inspection module 125A, an undercut inspection result display file generation module 125B, a thickness inspection module 130A, a thickness inspection result display file generation module 130B, thinness inspection module 135A, a thinness inspection result display file generation module 135B, a mold thinness inspection module 140A, a mold thinness inspection result display file generation module 140B, a product edge inspection module 145A, a product edge inspection result display file generation module 145B, mold edge inspection module 150A, a mold edge inspection result display file generation module 150B, a snap fit inspection module 155A, and a snap fit inspection result display file generation module 155B. Note that it is sufficient for the inspection processing module 120 to at least include the undercut inspection module 125A and the undercut inspection result display file generation module 125B. Furthermore, for an inspection conducted by the inspection processing module 120, an inspection made up of a combination of the above with any one or more from among the thickness inspection module 130A and the thickness inspection result display file generation module 130B, the thinness inspection module 135A and the thinness inspection result display file generation module 135B, the mold thinness inspection module 140A and the mold thinness inspection result display file generation module 140B, the product edge inspection module 145A and the product edge inspection result display file generation module 145B, the mold edge inspection module 150A and the mold edge inspection result display file generation module 150B, and the snap fit inspection module 155A and the snap fit inspection result display file generation module 155B may also be conducted.

The undercut inspection module 125A and the undercut inspection result display file generation module 125B are connected. The thickness inspection module 130A and the thickness inspection result display file generation module 130B are connected. The thinness inspection module 135A and the thinness inspection result display file generation module 135B are connected. The mold thinness inspection module 140A and the mold thinness inspection result display file generation module 140B are connected. The product edge inspection module 145A and the product edge inspection result display file generation module 145B are connected. The mold edge inspection module 150A and the mold edge inspection result display file generation module 150B are connected. The snap fit inspection module 155A and the snap fit inspection result display file generation module 155B are connected.

The undercut inspection module 125A conducts an undercut inspection process on the 3D information. An undercut refers to an indentation or protrusion in a shape that creates difficulty when attempting to withdraw a molded part from a metal mold by simply pushing in the open/close direction of the mold. Undercut processing may include an undercut processing mechanism such as a slide-out or a slide rod. If a product has an undercut, the mold for that part may be configured as a separate part (a slide core) that is moved every time the mold is opened or closed to make withdrawal easier. However, since such a metal mold typically has a complex structure, is expensive, and is also a potential cause of failure during molding, it is desirable to design products that do not have undercuts. Accordingly, the undercut inspection module 125A conducts an inspection process to determine whether or not 3D information received by the receiving module 105 has an undercut. The inspection process to determine whether or not an undercut exists may use established technology. For example, the number and sites of (a) diagonal slides, (b) standard slides, and (c) split planes or cavity/core split planes are computed as true undercuts or slide-outs. Specifically, the inspection items for an undercut may be (1) undercut site and (2) split plane. The inspection item (1) undercut site is an inspection of whether or not an undercut site exists, to avoid undercut processing and increased complexity of mold structure. The inspection item (2) split plane is an inspection of whether or not there exists a site where an undercut may be avoided by splitting a face with a cavity/core or standard slide, to avoid distinction between a true undercut and a diagonal slide/inward slide site.

The undercut inspection result display file generation module 125B generates inexpedience information for creating a 3D representation of an inexpedient part if the undercut inspection module 125A detects an inexpedient part. For example, the undercut inspection result display file generation module 125B generates a file for display that may be used to present a 3D display for indicating an undercut.

The thickness inspection module 130A conducts a thickness inspection process on the 3D information.

Thickness and thinness will now be described. Plastic varies in volume between the molten and solid states. Ordinarily, plastic contracts when hardening from a molten state. The ratio of this change is called the shrinkage ratio. Also, immediately after withdrawing a molded part from a metal mold, the temperature of the object is higher than normal, and first reaches normal temperature over a period of several hours or half a day. At this point, the molded part may shrink while cooling, and such error in the dimensions of a molded part is called mold shrinkage. The quantity of mold shrinkage basically differs depending on the type of plastic material, but also differs depending on factors such as the shape of molded part and the molding conditions. A metal mold is created larger in anticipation of mold shrinkage. Among thermoplastics, crystalline plastics exhibit large shrinkage values compared to non-crystalline plastics. Meanwhile, materials filled with glass fiber generally exhibit small shrinkage values, although the value may change depending on the type of filling material or reinforcing material, and the composition.

In addition, the shape of a product and the gate design of a metal mold may have the following relationship. When a molding material flows into a cavity via a gate in a metal mold, an orientation is exhibited in the plastic or filling material constituting the molding material. This orientation differs in aspect depending on the shape of the product and the placement of the gate, and a directionality is also exhibited in the value of the mold shrinkage ratio. Furthermore, since the above phenomenon may also become a factor causing deformation such as warping or twisting of the product, the gate shape of the metal mold may be designed to avoid such deformation. In gate design, typically there is a tendency for the mold shrinkage ratio to decrease as the size (cross-sectional area) of the gate increases.

Next, the relationship with the thickness of a product will be described. Even if molding material of the same type is used, if the thickness of the molded part becomes large, sink marks easily form on the surface, and generally there is a tendency for the mold shrinkage ratio to increase as the thickness of the molded part increases. If made thin, the flow distance becomes short (pressure propagation is reduced), potentially becoming a cause of a short mold. In addition, the number of gates used for filling is increased. If there are partially thick parts, cooling of the inside of the thick parts and cooling of the surface plane or base thickness may not be uniform, and may cause sink marks and warping or deformation. Accordingly, the thickness inspection module 130A conducts an inspection process to determine whether or not 3D information received by the receiving module 105 has thickness. The inspection process to determine whether or not thickness exists may use established technology. For example, the number and sites of portions exceeding the base thickness times A (where A is predetermined value, such as 1.2, for example) may be computed. Specifically, the inspection item for thickness may be (1) thickness. The inspection item (1) thickness is an inspection that compares the product overall to the base thickness and determines whether or not thickness exists, to avoid a molding inexpedience (such as sink marks or warping).

The thickness inspection result display file generation module 130B generates inexpedience information for creating a 3D representation of an inexpedient part if the thickness inspection module 130A detects an inexpedient part. For example, the thickness inspection result display file generation module 130B generates a file for display that may be used to present a 3D display for indicating thickness.

The thinness inspection module 135A conducts a thinness inspection process on the 3D information. As discussed above, incomplete filling (short mold) occurs readily in thin parts. Accordingly, the thinness inspection module 135A conducts an inspection process to determine whether or not 3D information received by the receiving module 105 has thinness. The inspection process to determine whether or not thinness exists may use established technology. For example, the number and sites of portions where the product thickness is less than B (where B is predetermined value, such as 1 mm, for example) may be computed. Specifically, the inspection item for thinness may be (1) thinness less than 1 mm. The inspection item (1) thinness less than 1 mm is an inspection of whether or not a thin part of less than 1 mm exists, to avoid a mold inexpedience (such as a short shot).

The thinness inspection result display file generation module 135B generates inexpedience information for creating a 3D representation of an inexpedient part if the thinness inspection module 135A detects an inexpedient part. For example, the thinness inspection result display file generation module 135B generates a file for display that may be used to present a 3D display for indicating thinness.

The mold thinness inspection module 140A conducts a mold thinness inspection process on the 3D information.

Mold thinness will now be described.

A long and narrow structural part of a metal mold is more susceptible to being bent by pressure during molding, and thus products are designed to have a moldable shape, in which circular (including elliptical) pin shapes satisfy h≧α×φd (where h is the length of the narrow part of the pin, and φd is the diameter of the narrow part of the pin) and flat pin shapes satisfy h≧β×a (where h is the length of the narrow part of the pin, and a is the length of the short edge on the top face of the pin), for example. Note that α and β are predetermined values, with α having a value such as 5 and β having a value such as 4, for example. The minimum values of d and a are taken to be predetermined values (for example, 1 mm). Accordingly, the mold thinness inspection module 140A conducts an inspection process to determine whether or not 3D information received by the receiving module 105 has mold thinness. The inspection process to determine whether or not mold thinness exists may use established technology. For example, the number and sites of portions where (1) the mold width is less than C (where c is a predetermined value, such as 1 mm, for example) and the mold height/width ratio is greater than a factor of D (where D is a predetermined value, such as 4, for example), (2) the mold width is less than C, and (3) the mold height/width ratio is greater than a factor of D, may be computed. Specifically, the inspection item for mold thinness may be (1) mold thinness. The inspection item (1) mold thinness is an inspection of whether or not the metal mold shape has a thin (less than 1 mm) portion and whether or not the metal mold shape has a site where the height (h) is greater than 4 times the width (w) (h/w>4), to avoid insufficient mold strength.

The mold thinness inspection result display file generation module 140B generates inexpedience information for creating a 3D representation of an inexpedient part if the mold thinness inspection module 140A detects an inexpedient part. For example, the mold thinness inspection result display file generation module 140B generates a file for display that may be used to present a 3D display for indicating mold thinness.

The product edge inspection module 145A conducts a product edge inspection process on the 3D information.

Product edge is an item for avoiding a filling inexpedience (short mold) in a thin part discussed earlier. Accordingly, the product edge inspection module 145A conducts an inspection process to determine whether or not 3D information received by the receiving module 105 has a product edge. The inspection process to determine whether or not a product edge exists may use established technology. For example, the number and sites of portions where a product edge exists may be computed. Specifically, the inspection item for product edge may be (1) product edge. The inspection item (1) product edge is an inspection of whether or not the product shape has an edge portion, to avoid difficulty in direct carving (as opposed to core splitting/electrical discharge machining) when machining the metal mold.

The product edge inspection result display file generation module 145B generates inexpedience information for creating a 3D representation of an inexpedient part if the product edge inspection module 145A detects an inexpedient part. For example, the product edge inspection result display file generation module 145B generates a file for display that may be used to present a 3D display for indicating a product edge portion.

The mold edge inspection module 150A conducts a mold edge inspection process on the 3D information.

Mold edge is a check item for ensuring mold strength, similar to the mold thinness discussed earlier. Accordingly, the mold edge inspection module 150A conducts an inspection process to determine whether or not 3D information received by the receiving module 105 has a mold edge. The inspection process to determine whether or not a mold edge exists may use established technology. For example, the number and sites of portions where (1) a mold edge is less than E (where E is a predetermined value, such as 60 degrees, for example) and (2) a mold edge is less than F (where F is a predetermined value, such as 89 degrees, for example) may be computed. Specifically, the inspection item for mold edge may be (1) mold edge. The inspection item (1) mold edge is an inspection of whether or not the metal mold shape has an edge portion, to avoid insufficient mold strength.

The mold edge inspection result display file generation module 150B generates inexpedience information for creating a 3D representation of an inexpedient part if the mold edge inspection module 150A detects an inexpedient part. For example, the mold edge inspection result display file generation module 150B generates a file for display that may be used to present a 3D display for indicating a mold edge portion.

The snap fit inspection module 155A conducts a snap fit inspection process on the 3D information.

A snap fit will now be described.

A shear edge refers to a site where mold cores directly interface in the movable direction of a metal mold. The cores interface while rubbing against each other each time the mold is opened and closed. A loose interface may produce flash, whereas a strong interface may produce fatigue failure in the metal mold. For this reason, a shear edge interface adjustment process may be conducted. Having a large number of shear edge planes tends to increase the mold fabrication period. Accordingly, designing a mold so as to reduce shear edge planes is desirable. To avoid interference from the metal mold and also reduce mold abrasion, shear edge planes may be given an angle of at least a predetermined value (such as 3 degrees, for example). Accordingly, the snap fit inspection module 155A conducts an inspection process to determine whether or not 3D information received by the receiving module 105 has a snap fit (shear edge shape). The inspection process to determine whether or not a snap fit exists may use established technology. For example, the number and sites of portions that are less than a gradient G (where G is a predetermined value, such as 5 degrees, for example), less than a plane H (where H is a predetermined value, such as 1 mm, for example) (that is, a gradient I, where I is a predetermined value, such as 5 degrees, for example), equal to or greater than a ratio of a shear edge gradient J (where J is a predetermined value, such as 5 degrees, for example) to a plane K (where K is a predetermined value, such as 1 mm, for example), or portions of corner mold thinness, may be computed. Specifically, the inspection items for snap fit may be (1) snap fit inspection and (2) corner mold thinness inspection. The inspection item (1) snap fit inspection is an inspection of whether the ratio of the shear edge to a planar part is ensured for a corner portion, to avoid insufficient mold strength. The inspection item (2) corner mold thinness inspection is an inspection of whether or not the metal mold shape has a site in a corner part where the height (h) is greater than 4 times the width (w) (h/w>4), to avoid insufficient metal mold strength.

The snap fit inspection result display file generation module 155B generates inexpedience information for creating a 3D representation of an inexpedient part if the snap fit inspection module 155A detects an inexpedient part. For example, the snap fit inspection result display file generation module 155B generates a file for display that may be used to present a 3D display for indicating a snap fit portion.

The inspection result processing module 160 is connected to the inspection processing module 120 and the output module 170. The inspection result processing module 160 associates an inspection result from the inspection processing module 120 with each inspection item and information used to create a 3D representation of inexpedient parts for each inspection item.

Additionally, the inspection result processing module 160 may also be configured to output, as the information indicating an inspection result by the inspection processing module 120, information for drawing lines indicating an inexpedient part (such as an undercut) on a face of an object represented by the 3D information. The “lines” are obviously lines that are distinguishable from the lines used to draw the object represented by the 3D information. For example, the “lines” may be in the form of an arrow, lines of different thickness or different color than the lines used to draw the object represented by the 3D information, dotted lines, or the like.

Furthermore, the inspection result processing module 160 may also be configured to output information for drawing a face which is an inexpedient part on the object represented by the 3D information, distinguishably from a face which is not an inexpedient part.

Furthermore, when the inspection processing module 120 conducts an inspection for any of thickness, thinness, product edge, and mold edge, the inspection result processing module 160 may also be configured to output information for drawing lines indicating an inexpedient part on a face of the object represented by the 3D information.

Furthermore, the inspection result processing module 160 may also be configured to output information for drawing a face which is an inexpedient part distinguishably from a face which is not an inexpedient part, and information for drawing lines indicating an inexpedient part on a face of the object represented by the 3D information.

Additionally, the inspection result processing module 160 may also be configured to output, as the information indicating an inspection result by the inspection processing module 120, information for drawing lines indicating an inexpedient part in a space configured by a face of the object represented by the 3D information.

A “space configured by a face” may be a space configured by multiple faces (such as the space between which two faces oppose each other, or a space enclosed by three faces, for example), but may also be a space configured by a single face (for example, a line whose start point and end point are points on a single face).

Furthermore, the inspection result processing module 160 may also be configured to output information for drawing a face which is an inexpedient part on the object represented by the 3D information, distinguishably from a face which is not an inexpedient part.

Furthermore, when the inspection processing module 120 conducts an inspection for any of undercut, mold thinness, and snap fit, the inspection result processing module 160 may also be configured to output information for drawing lines indicating an inexpedient part in a space configured by a face of the object represented by the 3D information.

Furthermore, when the inspection processing module 120 conducts an inspection for any of undercut and mold thinness, the inspection result processing module 160 may also be configured to output information for drawing a face which is an inexpedient part on the object represented by the 3D information distinguishably from a face which is not an inexpedient part, and information for drawing lines indicating an inexpedient part in a space configured by a face of the object represented by the 3D information.

The output module 170 is connected to the inspection result processing module 160. The output module 170 outputs inexpedience information in association with inspection items. The output module 170 may also be configured to use 3D shape information received by the receiving module 105 and the inexpedience information to output 3D information for display that includes an inexpedient part. Outputting information refers to, for example, displaying the information on a display device such as a monitor, transmitting the information to another information processing device via a communication network, writing the information to a storage device, and storing the information in a storage medium such as a memory card.

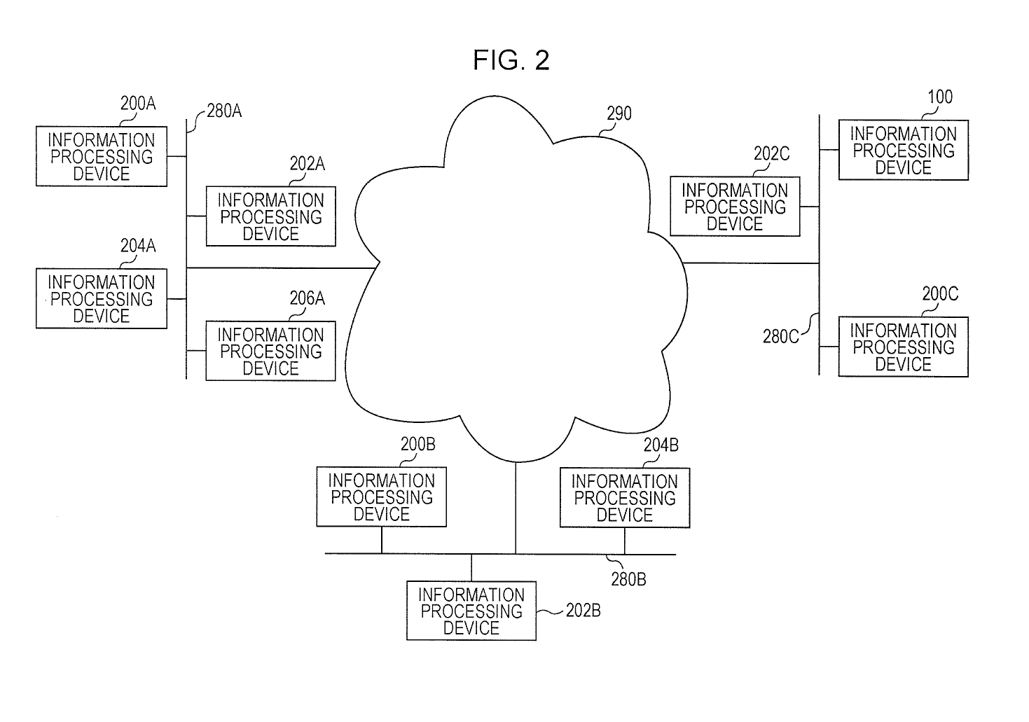

FIG. 2 is an explanatory diagram illustrating an exemplary system configuration applying an exemplary embodiment.

A communication network 290 is a communication network that connects a communication network 280A, a communication network 280B, and a communication network 280C, and uses the Internet as the communication infrastructure, for example. The communication network 280A, the communication network 280B, and the communication network 280C are communication networks that connect information processing devices 200 within respective organizations, and use an intranet as the communication infrastructure constructed within a company, for example.

The information processing device 200A, information processing device 202A, information processing device 204A, information processing device 206A, information processing device 200B, information processing device 202B, information processing device 204B, information processing device 200C, and information processing device 202C are connected to the information processing device 100 via the communication network 280A, communication network 280B, communication network 280C, or the communication network 290. The information processing device 100 provides a 3D information inspection process as what is called a cloud service (a design support system that includes a function for detecting fabrication problems). Each information processing device 200 is equipped with a web browser to pass 3D information to the information processing device 100 and submit an inspection instruction, receive an inspection result from the information processing device 100, and present the inspection result in a 3D display.

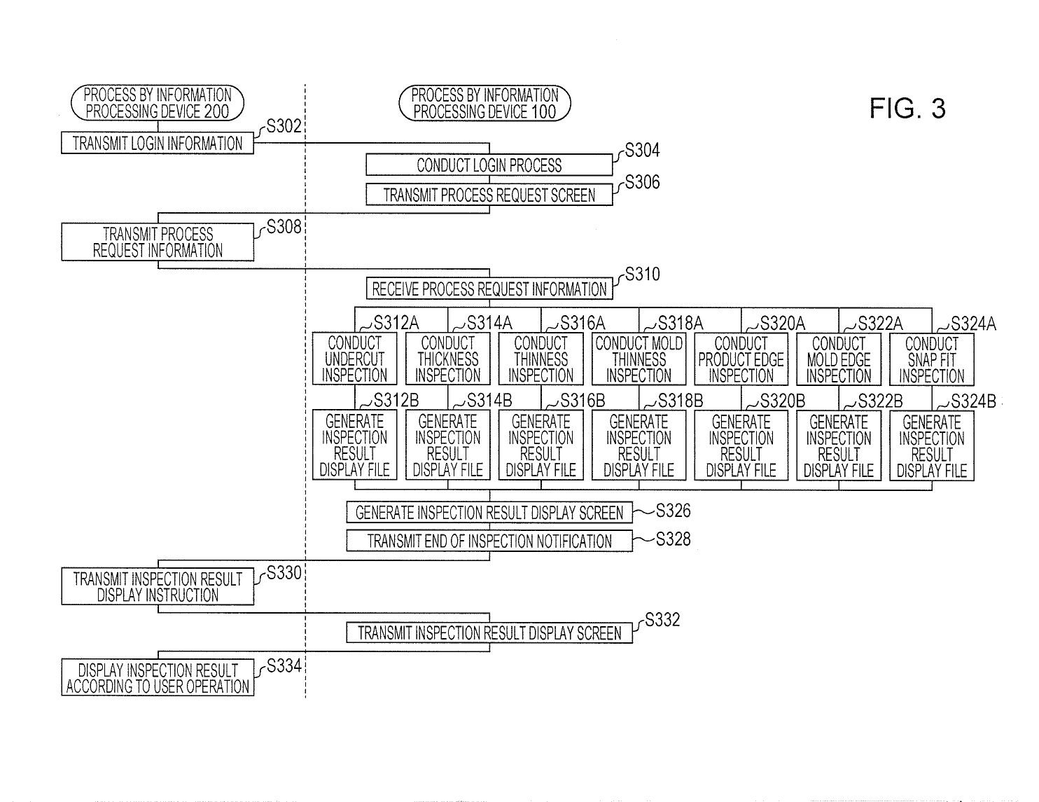

FIG. 3 is a flowchart illustrating an exemplary process according to the exemplary embodiment. An exemplary process conducted between the information processing device 100 and an information processing device 200 is illustrated.

In step S302, the information processing device 200 transmits login information. For example, a combination of a user ID and a password may be transmitted, or alternatively, information on an IC card carried by the user, or biometric information such as fingerprint information may be transmitted to the information processing device 100 as the login information. This information is used to log in to use the service of the inspection process according to the exemplary embodiment.

In step S304, the control module 110 conducts a login process. The login process is conducted on the basis of the login information transmitted in step S302. For example, it may be judged whether or not a combination of a user ID and a password matches information stored in the information processing device 100. If login is unsuccessful, a message indicating that the login was unsuccessful is transmitted to the information processing device 200.

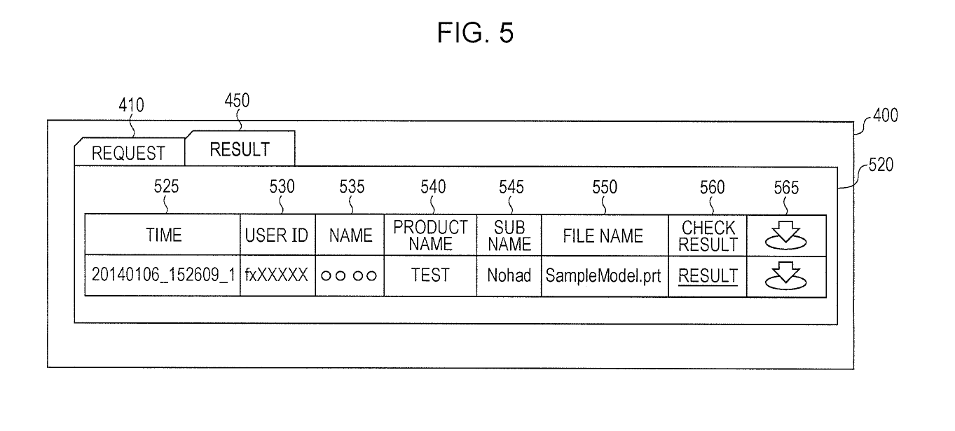

In step S306, the control module 110 transmits a process request screen. For example, a file for displaying the content of the screen 400 illustrated by the example of FIG. 4 (such as an HTML document) is transmitted. FIG. 4 is an explanatory diagram illustrating an example of a screen 400 used for an inspection request. The request tab 410 is an example of a process request screen. Note that the result tab 450 is a screen that displays an inspection result corresponding to a process request, as discussed later using the example of FIG. 5.

The request tab 410 includes a request receiving area 420. In the request receiving area 420, there are displayed a material field 422, an items to check field 424, a mold opening direction field 428, a base thickness field 430, a plate thickness field 432, a file name field 434, and a register button 436.

The material field 422 is a pull-down menu for specifying whether the 3D information to be inspected is plastic or compression-molded. Additionally, menu items for other types such as forged, cast, die-cast, glass, and rubber may also be provided.

In the items to check field 424, to configure the items and threshold values that the user wants to inspect, there are displayed an undercut check field 424A, a thickness check field 424B, a thinness check field 424C, a mold thinness check field 424D, a product edge check field 424E, a mold edge check field 424F, a snap fit check field 424G, an undercut threshold value field 426A, a thickness threshold value field 426B, a thinness threshold value field 426C, a mold thinness threshold value field 426D, a product edge threshold value field 426E, a mold edge threshold value field 426F, and a snap fit threshold value field 426G. The undercut threshold value field 426A corresponds to the undercut check field 424A, the thickness threshold value field 426B corresponds to the thickness check field 424B, the thinness threshold value field 426C corresponds to the thinness check field 424C, the mold thinness threshold value field 426D corresponds to the mold thinness check field 424D, the product edge threshold value field 426E corresponds to the product edge check field 424E, the mold edge threshold value field 426F corresponds to the mold edge check field 424F, and the snap fit threshold value field 426G corresponds to the snap fit check field 424G. Also, each of the threshold value fields 426 may be omitted or multiply provided. By default, all items may be checked, or one or more predetermined items (such as the undercut check field 424A) may be checked. Also, a default value may be entered into each of the threshold value fields 426, or a range of allowable threshold values may be configured. Additionally, if a value outside the range is entered, an error message may be displayed.

The mold opening direction field 428 specifies the mold opening direction expressed by the 3D information. The mold opening direction field 428 is a pull-down menu for specifying a direction such as the up-and-down direction, left-and-right direction, forward-and-back direction, or a diagonal direction with respect to a predetermined face of the object represented by the three-dimensional information, as discussed earlier. Also, the user may be made to specify a vector pointing in the opening direction. Note that a vector may also be specified by extracting the normal vector of a selected, specific face, or by extracting a vector component joining two selected, specific points.

The base thickness field 430 is displayed when plastic is selected in the material field 422, and is one type of value received by the receiving module 105 discussed earlier. The plate thickness field 432 is displayed when compression-molded is selected in the material field 422, and is one type of threshold value discussed earlier. Likewise for the base thickness field 430 and the plate thickness field 432, a default value may be entered, or a range of allowable threshold values may be configured. Additionally, if a value outside the range is entered, an error message may be displayed.

The file name field 434 is a field for uploading 3D information, and specifies the file name of a file containing 3D information. 3D information may also be directly uploaded from CAD software. As discussed earlier, fields other than the file name field 434 indicating the 3D information may be omitted. Consequently, all fields other than the file name field 434 may not be provided, or only some of these fields may be provided. Additionally, the user may also not enter information into the fields other than the file name field 434.

In step S308, the information processing device 200 transmits process request information. Described using the example of FIG. 4, when the user selects the register button 436, the contents of the fields such as the material field 422 at that time are transmitted to the information processing device 100.

In step S310, the receiving module 105 receives process request information.

In step S312A, the undercut inspection module 125A conducts an undercut inspection process on the 3D information received by the receiving module 105.

In step S312B, the undercut inspection result display file generation module 125B generates an inspection result display file.

In step S314A, the thickness inspection module 130A conducts a thickness inspection process on the 3D information received by the receiving module 105.

In step S314B, the thickness inspection result display file generation module 130B generates an inspection result display file.

In step S316A, the thinness inspection module 135A conducts a thinness inspection process on the 3D information received by the receiving module 105.

In step S316B, the thinness inspection result display file generation module 135B generates an inspection result display file.

In step S318A, the mold thinness inspection module 140A conducts a mold thinness inspection process on the 3D information received by the receiving module 105.

In step S318B, the mold thinness inspection result display file generation module 140B generates an inspection result display file.

In step S320A, the product edge inspection module 145A conducts a product edge inspection process on the 3D information received by the receiving module 105.

In step S320B, the product edge inspection result display file generation module 145B generates an inspection result display file.

In step S322A, the mold edge inspection module 150A conducts a mold edge inspection process on the 3D information received by the receiving module 105.

In step S322B, the mold edge inspection result display file generation module 150B generates an inspection result display file.

In step S324A, the snap fit inspection module 155A conducts a snap fit inspection process on the 3D information received by the receiving module 105.

In step S324B, the snap fit inspection result display file generation module 155B generates an inspection result display file.

The processing in steps S312A to S324A may be respectively conducted in parallel, or conducted sequentially. Also, processing may be conducted by using a result from another process (including an intermediate result).

In step S326, the inspection result processing module 160 generates an inspection result display screen. For example, the inspection result processing module 160 generates a file for presenting a 3D display of the inspection result from step S312A and the like.

In step S328, the output module 170 transmits an end of inspection notification. For example, an email or the like is used to notify the user who submitted the inspection process request. At this point, a download location (such as a URL) of the file generated in step S326 may also be included in the content of the email or the like.

In step S330, the information processing device 200 transmits an inspection result display instruction.

In step S332, the output module 170 transmits an inspection result display screen. For example, a file for displaying the content in the inspection process notification area 520 illustrated by the example of FIG. 5 (such as an HTML document) is transmitted. FIG. 5 is an explanatory diagram illustrating an example of a screen 400 that displays an inspection result. The inspection process notification area 520 is an example of a screen when the result tab 450 is selected.

In the inspection process notification area 520, there are displayed a time field 525, a user ID field 530, a name field 535, a product name field 540, a sub name field 545, a file name field 550, a check result field 560, and a download instruction field 565. The time field 525 displays the time when the inspection process was conducted (the time may be the year, month, day, hour, minute, second, fraction of a second, or some combination thereof). The name field 535 displays the user ID of the user who submitted the inspection request. The name field 535 displays the name of the user. The product name field 540 and the sub name field 545 display a product name and a sub name of the 3D information to be inspected. The file name field 550 displays the file name of the 3D information to be inspected. The check result field 560 displays a URL for displaying the inspection result in a web browser. If this field is selected by the user, a screen as illustrated by the example of FIG. 6 discussed later is displayed. The download instruction field 565 displays an icon for downloading inspection result data. For example, a file for displaying a screen as illustrated by the example of FIG. 6 (data for a viewer application) is downloadable. Also, a file of the 3D information to be inspected (the file indicated in the file name field 550, or CAD data) may also be downloadable.

Note that the product name field 540 and the sub name field 545 may also be omitted. However, in the case of adding the product name field 540 and the sub name field 545, a product name field and a sub name field are added to the screen 400 illustrated by the example of FIG. 4, and a process using the product name and the sub name may be conducted. For example, information such as a request item using the screen 400 or an inspection result for the request may be stored as a log and transmitted to the user who submitted the request, or to a person related to the relevant product or sub-category (specifically, a log may be transmitted to an address (such as an email address) of a person extracted from a table that stores information such as managers associated with the relevant product or sub-category).

In step S334, the information processing device 200 displays an inspection result in accordance with a user operation. The display format will be described using FIGS. 6 to 14.

FIG. 6 is an explanatory diagram illustrating an example of a screen 400 that presents a 3D display of an inspection result. On the screen 400, there are displayed a check result table 610 and a 3D display area 690.

The check result table 610 is an object that displays an inspection result in table format, and includes a check result field 615 and a guide field 670. The check result field 615 includes an item field 620, a details field 660, and a result (value) field 665.

The item field 620 displays inspection items. These inspection items correspond to the inspection results from the inspection modules in the inspection processing module 120, and correspond to the checked items in the items to check field 424 illustrated in the example of FIG. 4. One or more of any of an undercut field 625, a thickness field 630, a thinness field 635, a mold thinness field 640, a product edge field 645, a mold edge field 650, and a snap fit field 655 are displayed as the item field 620. At least the undercut field 625 may be displayed.

The details field 660 displays detailed items about each inspection item. The result (value) field 665 displays an inspection result (such as yes/no, or the number of relevant inexpedient parts) for each item in the details field 660. For the undercut field 625, (1) true undercut, (2) slide out, (2a) diagonal slide, (2b) standard slide, (2c) split plane, and (3) cavity/core split plane are displayed as an inspection result from the undercut inspection module 125A. For the thickness field 630, (1) portions exceeding the base thickness×A (such as 1.1, 1.2, 1.3, or 1.4, for example) are displayed as an inspection result from the thickness inspection module 130A. For the thinness field 635, (1) portions where the product thickness is less than B (such as 1, 2, or 3 mm, for example) are displayed as an inspection result from the thinness inspection module 135A. For the mold thinness field 640, (1) portions where the mold width is less than C (such as 1, 2, or 3 mm, for example) and the mold height/width ratio is greater than a factor of D (such as 3, 4, 5, or 6, for example), (2) portions where the mold width is less than C, and (3) portions where the mold height/width ratio is greater than a factor of D are displayed as an inspection result from the mold thinness inspection module 140A. For the product edge field 645, (1) product edge portions are displayed as an inspection result from the product edge inspection module 145A. For the mold edge field 650, (1) mold edge portions (less than E (such as 55, 60, 65, or 70 degrees, for example)) and (2) mold edge portions (less than F (such as 86, 87, 88, 89, 90, 91, or 92 degrees, for example)) are displayed as an inspection result from the mold edge inspection module 150A. For the snap fit field 655, (1) portions less than a gradient G (such as 3, 4, 5, 6, or 7 degrees, for example), (2) portions less than a plane H (such as 1, 2, or 3 mm, for example) (that is, a gradient I (such as 3, 4, 5, 6, or 7 degrees, for example)), (3) portions equal to or greater than a ratio of a shear edge gradient J (such as 3, 4, 5, 6, or 7 degrees, for example)/plane K (such as 1, 2, or 3 mm, for example), and (4) portions of snap fit mold thinness are displayed as an inspection result from the snap fit inspection module 155A.

The guide field 670 displays an “Open” button for displaying a description of a relevant inspection item. When the “Open” button for an inspection item is selected, a description of the inspection item, methods of improving inexpedient parts, and the like are displayed using a popup window or the like.

In the 3D display area 690, there is presented a 3D display of the object represented by the 3D information to be inspected. According to user operations, the 3D display may be rotated, enlarged, and reduced, or a 2D cross-sectional display or the like may be presented. Additionally, as an inspection result, inexpedient parts are displayed differently from other portions (sites that are not inexpedient parts).

When an inexpedient part exists as an inspection result, one or a combination of any of the item field 620, the details field 660, and the result (value) field 665 for an item may be displayed in a different format to distinguish the relevant item from items that do not have an inexpedient part. For example, a light green background may be applied to the item field 620 of an inspection item that does not have an inexpedient part, while a red background may be applied to the item field 620 of an inspection item that has an inexpedient part. In addition, besides color, an inspection item may be differentiated by line boldness, line shape (such as dotted lines or solid lines), a pattern, and animation or the like. For example, an inspection item that has an inexpedient part may be presented with a flashing display or the like.

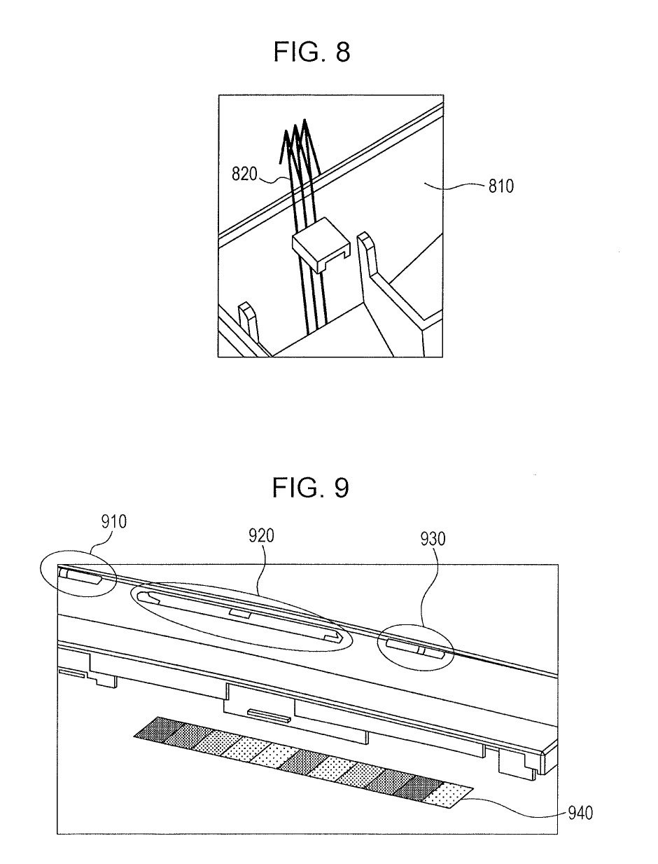

Additionally, when an item that has an inexpedient part (any one of the items of the item field 620, the details field 660, and the result (value) field 665) is selected by a user operation, a 3D display of the corresponding inexpedient part may be presented in the 3D display area 690. In other words, since an inspection item in the check result table 610 is associated with an inexpedient part in the 3D display area 690, when an inspection item in the check result table 610 is selected, the inexpedient part for that inspection item is displayed in the 3D display area 690. For example, if the link in the undercut field 625 of the item field 620 is clicked by a user operation, an inexpedient part colored in a model displayed in 3D in the 3D display area 690 may be checked. Display methods for each inspection item will be discussed later using FIGS. 8 to 14.

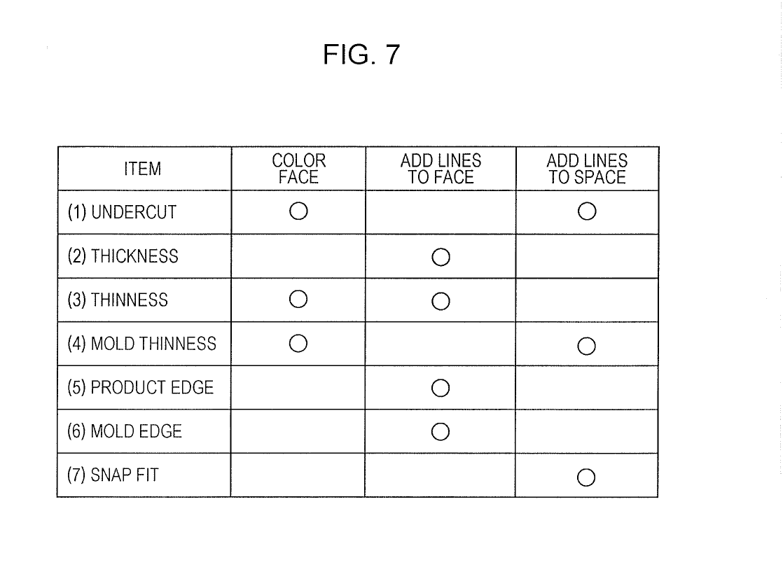

FIG. 7 is an explanatory diagram illustrating an example of combinations of display formats for inspection items.

The table illustrated in the example of FIG. 7 illustrates display formats for inexpedient parts when presenting a 3D display of each inspection item. In other words, for (1) undercut, “color face” and “add lines to space” are conducted, for (2) thickness, “add lines to face” is conducted, for (3) thinness, “color face” and “add lines to face” are conducted, for (4) “color face” and “add lines to space” are conducted, for (5) product edge, “add lines to face” is conducted, for (6) mold edge, “add lines to face” is conducted, and for (7) snap fit, “add lines to space” is conducted. “Color face” refers to painting a face with a color different from other faces when the face itself of the object (or mold) represented by the 3D information is an inexpedient part. “Add lines to face” refers to drawing lines at the site on a face where an inexpedience occurs. Note that the lines may not only be linear shapes such as straight lines, curved lines, and arrows, but may also be shapes such as characters and symbols. In addition, the lines may also be colored. “Add lines to space” refers to drawing lines in a “space configured by a face” as discussed earlier.

Note that the different representations of inspection results generally may be used as follows.

(1) Color face: when it is sufficient to indicate an entire face of the 3D information to display

(2) Lines on face: when indicating a specific portion of a face of the 3D information to display

(3) Lines in space: when indicating a portion lacking an element of the 3D information to display

For example, for thinness, in order to indicate which portion of which face has thinness, a combination of a color face and lines on a face may be used to represent the thinness.

Representations for each of the other items are as follows.

Undercut

A color face is used to indicate the face corresponding to an inexpedient part from an undercut inspection. Lines in space (arrow display) are used to indicate the relevant site and direction of the undercut.

Thickness

Lines on a face are used to indicate a site corresponding to an inexpedient part from a thickness inspection. A color face may also be used. However, a color face may also not be used when the varieties of line colors to display exceed a predetermined value, in order to avoid making the representation more difficult to see by additionally using a color face.

Mold Thinness

A color face is used to indicate the face corresponding to an inexpedient part from a mold thinness inspection. Additionally, lines in a space are used to indicate the relevant site. Note that the relevant site is a portion of the metal mold, at a site where the molded part does not exist.

Product Edge/Mold Edge

Lines on a face are used to indicate an edge corresponding to an inexpedient part from a product edge/mold edge inspection. Note that the ends of a face are edges, and thus are treated as lines on the face.

Snap Fit

Lines in a space are used to simply draw and indicate the metal mold shape of a site corresponding to an inexpedient part from a snap fit inspection.

FIG. 8 is an explanatory diagram illustrating an exemplary display of an inspection result. FIG. 8 illustrates an exemplary display in the 3D display area 690 of an inspection result from the undercut inspection module 125A. This exemplary display is a display of black review site display arrows (lines) 820 at the undercut site of a true undercut face 810. Note that arrows pointing in multiple directions from the same site may be displayed in some cases.

FIG. 9 is an explanatory diagram illustrating an exemplary display of an inspection result. FIG. 9 illustrates an exemplary display in the 3D display area 690 of an inspection result from the thickness inspection module 130A. This exemplary display is for a case in which there are three inexpedient parts as the thickness inspection result, and draws colored circle symbols (the inexpedient part display lines 910, 920, and 930) at the thickness sites which are the inexpedient parts. A color bar is displayed as a legend for reference. For example, an inspection is conducted over a range from base thickness×A mm to (base thickness×A mm)+3 mm, and gradation colors are added and displayed like in the legend 940.

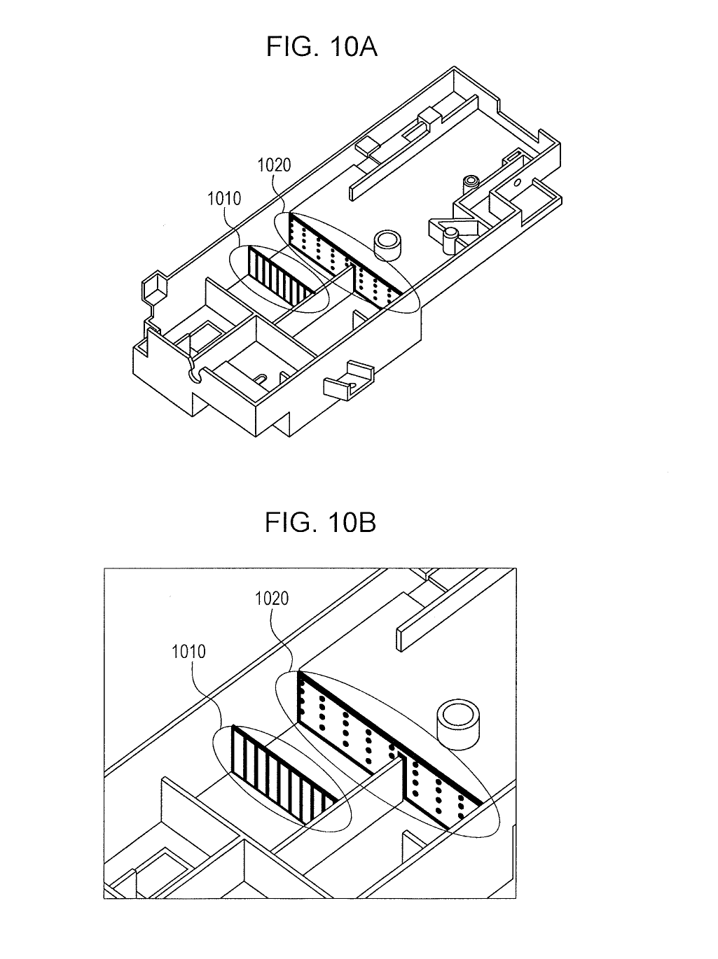

FIGS. 10A and 10B are explanatory diagrams illustrating an exemplary display of an inspection result. FIG. 10A illustrates an exemplary display in the 3D display area 690 of an inspection result from the thinness inspection module 135A, while FIG. 10B is an enlarged view of the same. This exemplary display draws solid red lines at a site 1010 that is less than B mm, and paints the color of the face with a pink color. In addition, this exemplary display draws dotted blue lines at a site 1020 that is less than B mm and equal to or greater than B1 mm (such as 0.4, 0.5, 0.6, 0.7, or 0.8 mm, for example), and paints the color of the face with a pink color.

FIG. 11 is an explanatory diagram illustrating an exemplary display of an inspection result. FIG. 11 illustrates an exemplary display in the 3D display area 690 of an inspection result from the mold thinness inspection module 140A. This exemplary display draws lines at a site where the mold width (w) is less than C mm, as inexpedient part display arrows (lines) 1117 which are doubled-ended arrows on a review face 1115 in an enlarged display area 1110.

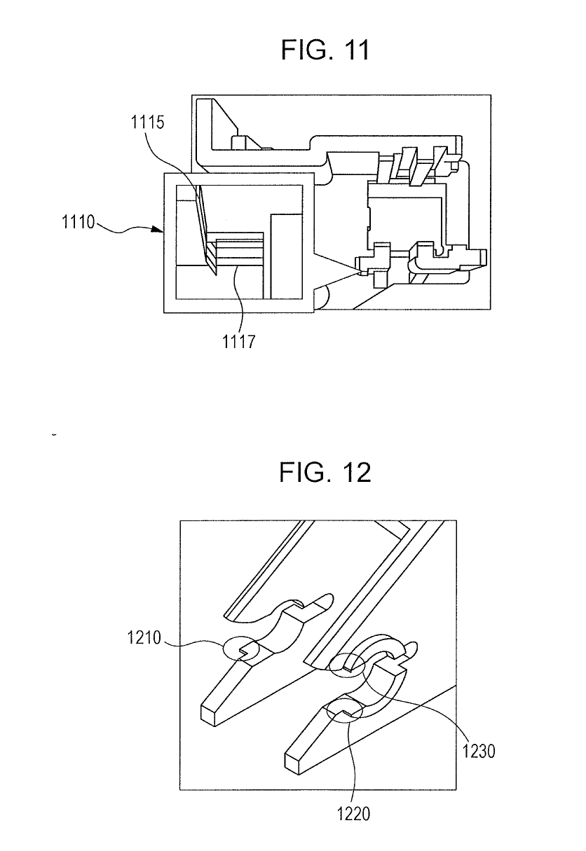

FIG. 12 is an explanatory diagram illustrating an exemplary display of an inspection result. FIG. 12 illustrates an exemplary display in the 3D display area 690 of an inspection result from the product edge inspection module 145A. This exemplary display draws magenta lines on the edge of an inexpedient part, like the inexpedient part display lines 1210, 1220, and 1230.

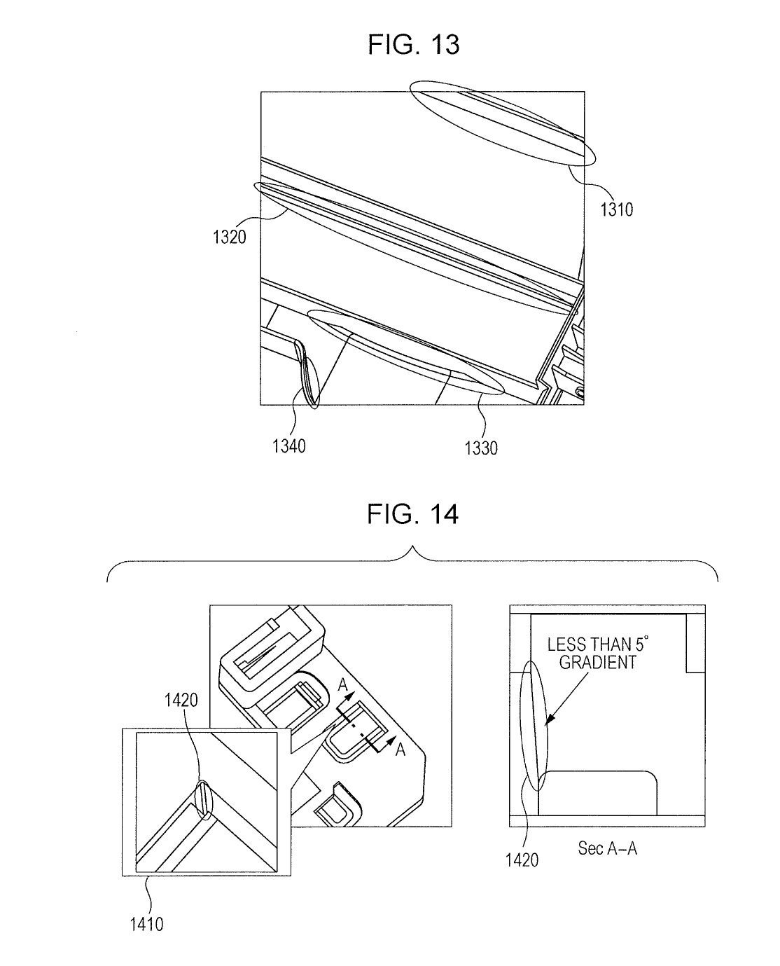

FIG. 13 is an explanatory diagram illustrating an exemplary display of an inspection result. FIG. 13 illustrates an exemplary display in the 3D display area 690 of an inspection result from the mold edge inspection module 150A. This exemplary display draws magenta lines at an inexpedient part where the mold edge is less than E degrees, and draws green lines at an inexpedient part where the mold edge is less than F degrees, like the inexpedient part display lines 1310, 1320, 1330, and 1340.

FIG. 14 is an explanatory diagram illustrating an exemplary display of an inspection result. FIG. 14 illustrates an exemplary display in the 3D display area 690 of an inspection result from the snap fit inspection module 155A. This exemplary display indicates a fill site where a shear edge gradient of at least G degrees is not ensured as an inexpedient part by drawing an inexpedient part display line 1420 in an enlarged display area 1410 as illustrated on the left side of FIG. 14. Also, the inexpedient part display line 1420 is drawn on the A-A cross-section on the left side of FIG. 14, as illustrated on the right side of FIG. 14.

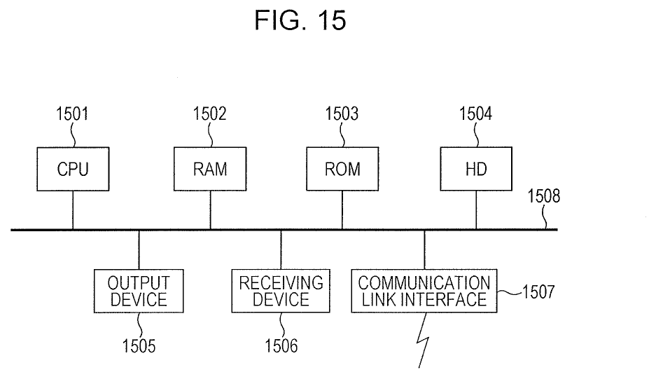

Note that a hardware configuration of a computer executing a program that acts as the present exemplary embodiment is a general computer as illustrated by the example of FIG. 15, and specifically is a computer or the like that may be a personal computer or a server. In other words, as a specific example, a CPU 1501 is used as a processing unit (computational unit), while RAM 1502, ROM 1503, and an HD 1504 are used as storage devices. For the HD 1504, a hard disk may be used, for example. The computer is made up of the CPU 1501 that executes programs such as the receiving module 105, the control module 110, the undercut inspection module 125A, the undercut inspection result display file generation module 125B, the thickness inspection module 130A, the thickness inspection result display file generation module 130B, the thinness inspection module 135A, the thinness inspection result display file generation module 135B, the mold thinness inspection module 140A, the mold thinness inspection result display file generation module 140B, the product edge inspection module 145A, the product edge inspection result display file generation module 145B, the mold edge inspection module 150A, the mold edge inspection result display file generation module 150B, the snap fit inspection module 155A, the snap fit inspection result display file generation module 155B, the inspection result processing module 160, and the output module 170, the RAM 1502 that stores such programs and data, the ROM 1503 that stores programs and the like for activating the computer, the HD 1504 which is an auxiliary storage device (and which may be flash memory or the like), a receiving device 1506 that receives data on the basis of user operations with respect to a keyboard, mouse, touch panel, or the like, an output device 1505 such as a CRT or liquid crystal display, a communication link interface 1507 such as a network interface card for connecting to a communication network, and a bus 1508 for joining and exchanging data with the above components. Multiple such computers may also be connected to each other by a network.

Of the foregoing exemplary embodiments, for those made up of a computer program, software in the form of a computer program is made to be read into a system with the above hardware configuration, and the foregoing exemplary embodiments are realized by the cooperative action of the software and hardware resources.

Note that the hardware configuration illustrated in FIG. 15 illustrates a single exemplary configuration, and that the exemplary embodiments are not limited to the configuration illustrated in FIG. 15 insofar as the configuration still enables execution of the modules described in the exemplary embodiments. For example, some modules may also be realized with special-purpose hardware (such as an ASIC, for example), and some modules may be configured to reside within an external system and be connected via a communication link. Furthermore, it may also be configured such that multiple instances of the system illustrated in FIG. 15 are connected to each other by a communication link and operate in conjunction with each other. Additionally, besides a personal computer in particular, an exemplary embodiment may also be incorporated into a device such as a photocopier, fax machine, scanner, printer, or multi-function device (that is, an image processing device having two or more from among scanning, printing, copying, and faxing functions).

In addition, the exemplary embodiments discussed above may also be configured as the following, or in combination with the following.

(1A) An information processing device including:

an inspection unit that conducts, on three-dimensional (3D) information, a mold requirement inspection for fabricating an object represented by the 3D information; and

an output unit that outputs, as information indicating an inspection result by the inspection unit, information for drawing lines indicating inexpedient part on a face of the object represented by the 3D information.

(2A) The information processing device according to (1A), wherein

the output unit outputs information for drawing a face which is an inexpedient part on the object represented by the 3D information, distinguishably from a face which is not an inexpedient part.

(3A) The information processing device according to (1A) or (2A), wherein

a mold requirement inspection for one or more of any of undercut, thickness, thinness, mold thinness, product edge, mold edge, and snap fit is conducted as a mold requirement inspection conducted by the inspection unit, and

when the inspection unit conducts a mold requirement inspection for any of thickness, thinness, product edge, and mold edge, the output unit outputs information for drawing lines indicating an inexpedient part on a face of the object represented by the 3D information.

(4A) The information processing device according to (2A), wherein

when the inspection unit conducts a mold requirement inspection for thinness, the output unit outputs information for drawing a face which is an inexpedient part on the object represented by the 3D information distinguishably from a face which is not an inexpedient part, and information for drawing lines indicating an inexpedient part on a face of the object represented by the 3D information.

(5A) An information processing program causing a computer to function as:

an inspection unit that conducts, on three-dimensional (3D) information, a mold requirement inspection for fabricating an object represented by the 3D information; and

an output unit that outputs, as information indicating an inspection result by the inspection unit, information for drawing lines indicating inexpedient part on a face of the object represented by the 3D information.

(1B) An information processing device including:

an inspection unit that conducts, on three-dimensional (3D) information, a mold requirement inspection for fabricating an object represented by the 3D information; and

an output unit that outputs, as information indicating an inspection result by the inspection unit, information for drawing lines indicating inexpedient part in a space configured by a face of the object represented by the 3D information.

(2B) The information processing device according to (1B), wherein

the output unit outputs information for drawing a face which is an inexpedient part on the object represented by the 3D information, distinguishably from a face which is not an inexpedient part.

(3B) The information processing device according to (1B) or (2B), wherein

a mold requirement inspection for one or more of any of undercut, thickness, thinness, mold thinness, product edge, mold edge, and snap fit is conducted as a mold requirement inspection conducted by the inspection unit, and

when the inspection unit conducts a mold requirement inspection for any of undercut, mold thinness, and snap fit, the output unit outputs information for drawing lines indicating an inexpedient part in a space configured by a face of the object represented by the 3D information.

(4B) The information processing device according to (2B), wherein

when the inspection unit conducts a mold requirement inspection for any of undercut and mold thinness, the output unit outputs information for drawing a face which is an inexpedient part on the object represented by the 3D information distinguishably from a face which is not an inexpedient part, and information for drawing lines indicating an inexpedient part in a space configured by a face of the object represented by the 3D information.

(5B) An information processing program causing a computer to function as:

an inspection unit that conducts, on three-dimensional (3D) information, a mold requirement inspection for fabricating an object represented by the 3D information; and

an output unit that outputs, as information indicating an inspection result by the inspection unit, information for drawing lines indicating inexpedient part in a space configured by a face of the object represented by the 3D information.

Note that a program described above may be provided stored in a recording medium, but the program may also be provided via a communication medium. In this case, a computer-readable recording medium storing a program, for example, may also be taken to be an exemplary embodiment of the present invention with respect to the described program.

A “computer-readable recording medium storing a program” refers to a computer-readable recording medium upon which a program is recorded, and which is used in order to install, execute, and distribute the program, for example.

The recording medium may be a Digital Versatile Disc (DVD), encompassing formats such as DVD-R, DVD-RW, and DVD-RAM defined by the DVD Forum and formats such as DVD+R and DVD+RW defined by DVD+RW Alliance, a compact disc (CD), encompassing formats such as read-only memory (CD-ROM), CD Recordable (CD-R), and CD Rewritable (CD-RW), a Blu-ray Disc (registered trademark), a magneto-optical (MO) disc, a flexible disk (FD), magnetic tape, a hard disk, read-only memory (ROM), electrically erasable and programmable read-only memory (EEPROM (registered trademark)), flash memory, random access memory (RAM), or a Secure Digital (SD) memory card, for example.

In addition, all or part of the above program may also be recorded to the recording medium and saved or distributed, for example. Also, all or part of the above program may be communicated by being transmitted using a transmission medium such as a wired or wireless communication network used in a local area network (LAN), a metropolitan area network (MAN), a wide area network (WAN), an internet, an intranet, an extranet, or some combination thereof, or alternatively, by being impressed onto a carrier wave and propagated.

Furthermore, the above program may be part of another program, and may also be recorded to a recording medium together with other separate programs. The above program may also be recorded in a split manner across multiple recording media. The above program may also be recorded in a compressed, encrypted, or any other recoverable form.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
a receiving unit that receives three-dimensional (3D) information at least including a 3D shape;
an inspection unit that conducts, on the 3D information, a mold requirement inspection at least including undercut as a mold requirement inspection for fabricating an object represented by the 3D information;
a generating unit that, when the inspection unit detects an inexpedient part, generates inexpedience information for creating a 3D representation of the inexpedient part; and
an output unit that outputs the inexpedience information in association with an inspection item.

2. The information processing device according to claim 1, wherein
the output unit uses 3D shape information received by the receiving unit and the inexpedience information to output 3D information for display that includes an inexpedient part.

3. The information processing device according to claim 1, wherein
a mold requirement inspection for one or more of any of thickness, thinness, mold thinness, product edge, mold edge, and snap fit is additionally conducted as a mold requirement inspection conducted by the inspection unit.

4. The information processing device according to claim 1, further comprising:
a specifying unit that specifies a mold opening direction from the 3D information;
wherein the inspection unit conducts an inspection on the basis of the specified mold opening direction.

5. The information processing device according to claim 1, wherein
the receiving unit receives an inspection item to be conducted by the inspection unit, and
when the receiving unit receives the inspection item, the inspection unit conducts a mold requirement inspection corresponding to the inspection item.

6. The information processing device according to claim 1, wherein
the receiving unit receives a value corresponding to an inspection item to be conducted by the inspection unit, and
when the receiving unit receives the value, the inspection unit conducts a mold requirement inspection of a corresponding inspection item in accordance with the value.

7. The information processing device according to claim 1, wherein
the receiving unit receives a mold opening direction expressed by the 3D information, and
when the receiving unit receives the mold opening direction expressed by the 3D information, the inspection unit conducts a mold requirement inspection in accordance with the received opening direction.

8. An information processing method comprising:
receiving three-dimensional (3D) information at least including a 3D shape;
conducting, on the 3D information, a mold requirement inspection at least including undercut as a mold requirement inspection for fabricating an object represented by the 3D information;
generating, when the inspecting detects an inexpedient part, inexpedience information for creating a 3D representation of the inexpedient part; and
outputting the inexpedience information in association with an inspection item.

9. A non-transitory computer readable medium storing a program causing a computer to execute a process for processing information, the process comprising:
receiving three-dimensional (3D) information at least including a 3D shape;
conducting, on the 3D information, a mold requirement inspection at least including undercut as a mold requirement inspection for fabricating an object represented by the 3D information;
generating, when the inspecting detects an inexpedient part, inexpedience information for creating a 3D representation of the inexpedient part; and
outputting the inexpedience information in association with an inspection item.
